(19) United States
(12) Patent Application Publication
(10) Pub. No.: US 2012/0114108 A1
(43) Pub. Date: May 10, 2012

(54) MESSAGING COMMUNICATION APPLICATION

(75) Inventors: Thomas E. Katis, Jackson, WY (US); James T. Panttaja, Healdsburg, CA (US); Mary G. Panttaja, Healdsburg, CA (US); Matthew J. Ranney, Oakland, CA (US)

(73) Assignee: VOXER IP LLC, San Francisco, CA (US)

(21) Appl. No.: 13/245,690

(22) Filed: Sep. 26, 2011

Related U.S. Application Data
(60) Provisional application No. 61/386,922, filed on Sep. 27, 2010.

(51) Int. Cl. H04M 11/00

(52) U.S. Cl. 379/88.13

(57) ABSTRACT

A messaging application that includes a transmit module configured to progressively transmit time-based media of a message to a recipient as the media is created. The transmit module transmits the message in either a messaging mode where the time-based media of the message is transmitted before a delivery route to the recipient is completely discovered or a call mode where the transmission occurs after providing a notification requesting synchronous communication and receiving a confirmation that the recipient would like to engage in synchronous communication. In response to the notification, the recipient has the option of rendering the incoming message in either a real-time mode as the time-based media of the message is received or a time-shifted mode by rendering the time-based media of the message at an arbitrary later time after it was received.

### CROSS REFERENCE TO RELATED APPLICATIONS

This application claims priority under 35 U.S.C. 119(e) to U.S. Provisional Patent Application No. 61/386,922, filed on Sep. 27, 2010, which is incorporated herein by reference in its entirety for all purposes.

### BACKGROUND

1. Field of the Invention

This invention relates to communications, and more particularly, to a messaging communication application that allows received messages to be received and rendered in a real-time mode or in a time-shifted mode and includes rendering options to seamlessly transition the rendering of the received messages between the two modes.

2. Description of Related Art

In spite of being a mature technology, telephony has changed little over the years. Similar to the initial telephone system developed over a hundred years ago, a telephone call today still requires a circuit connection between the parties before voice can be transmitted. If a circuit connection is not established, for whatever reason, no communication can take place.

A known advancement in telephony is voice mail. If a call is made and the recipient does not answer the phone, then the call is “rolled-over” into a separate voice mail system, typically maintained on a voice mail server or an answering machine connected to the phone of the recipient. The telephone and voice mail systems, however, are not integrated. Rather, the voice mail services are “tacked-on” to the phone system. The fact that the two systems are separate and distinct, and not integrated, creates a number of inconveniences and inefficiencies.

Consider a real-world situation where two parties wish to have a conversation. If party A makes a call while party B is busy, then after the phone rings numerous times, party A is eventually rolled over into the voice mail of party B. Only after listening to and navigating through the voice mail system, can party A leave a message. To retrieve the message, party B is required to call into the voice mail system, possibly listen to other messages first in the queue, before listening to the message left by party A. In reply, party B may call party A. If party A is busy, the above process is repeated. This sequence may occur multiple times as the two parties attempt to reach each other. Eventually, one of the parties will place a call and a live circuit will be established. Only at this point is it possible for the two parties to engage in a live conversation. The difficulty and time wasted for the two parties to communicate through voice mail, as highlighted in this real-world example, is attributable to the fact that the telephone system and voice mail are two different systems that do not interoperate very well together.

With the advent of the Internet, telephony based on Voice over Internet Protocol or VoIP has become popular. Despite a number of years of development, VoIP services today are little different than traditional telephony. Add on services like voicemail, email notifications and phonebook auto-dialing, are all common with VoIP. The fundamental communication service of VoIP, however, remains the same. A party is still required to place a call and wait for a connection to be made. If the recipient does not answer, the call is rolled over into voice mail, just like conventional telephony. VoIP has therefore not changed the fundamental way people communicate.

Visual voice mail is a recent advancement in telephony. With visual voice mail, a list of received messages is visually presented on a display of a communication device of a recipient, such as a mobile phone. The recipient may select any of the messages in the list to either listen to or delete, typically by simply touching the display adjacent where the message appears. When a message is selected for review, the media of the message is immediately rendered, without the user having to either (i) dial-in to the voice mail system or (ii) listen to previously received messages in the queue. In various implementations of visual voice mail, the message selected for review either is locally stored on the communication device itself, or is retrieved from the mail server and then rendered. When a message is selected for deletion, the selected message is removed from the list appearing on the display and also possibly removed from storage, either on the communication device itself, the network, or both.

One current example of a product including visual voice mail is the iPhone® by Apple Inc. of Cupertino, Calif. With visual voice mail on the iPhone®, incoming messages are first received and stored on the voice mail server of a recipient. Once the message is received in full, the message is downloaded to the iPhone® of the recipient and the recipient is notified. At this point, the recipient may review the message, or wait to review the message at an arbitrary later time. With visual voice mail on the iPhone®, however, incoming voice messages can never be rendered “live” in a real-time rendering mode because the message must be received in full before it can be rendered.

“Google Voice” offers additional improvements to conventional telephone systems. With Google Voice, one telephone number may be used to ring multiple communication devices, such as the desktop office phone, mobile phone, and home phone of a user. In addition, Google Voice offers a single or unified voicemail box for receiving all messages in one location, as opposed to separate voicemail boxes for each communication device. Google Voice also offers a number of other features, such as accessing voice mails online over the Internet, automatic transcriptions of voice mail messages into text messages, the ability to create personalized greetings based on who is calling, etc. In addition, Google Voice also provides a recipient with the options to either (i) listen to incoming messages “live” as the media of the message is received (ii) or join the live conversation with the person leaving the message. With both options, the recipient can either listen live or enter a live conversation only at the current most point of the incoming message.

With Google Voice, however, the rendering options for reviewing incoming messages are limited. There is no ability to; (i) review the previous portions of a message, behind the current most point, while the message is being left; (ii) seamlessly transition the review of an incoming message from a time-shifted mode to a synchronous real-time mode after catching up to the “live” point of the incoming message; or (iii) reply to an incoming voice message with a text message, or vice versa, using a single unified communication application.

Another drawback to each of the voice mail systems mentioned above is that a circuit connection always must be established before the recipient of a message can reply with either a live voice conversation or another voice message. For example if a person would like to talk to the sender of a voice mail, the recipient is required to dial the telephone number of the sender of the message. Again if the called party does not answer, then a voice mail message may be left once a circuit connection is established with the voice mail system.

Alternatively, some visual voice mail systems have a “compose” feature, allowing the recipient to generate a reply message. Once the message is created, it may be transmitted. A circuit connection still, however, must be established before the composed message can be delivered.

### SUMMARY OF THE INVENTION

The invention pertains to a messaging application. The application includes a transmit module configured to progressively transmit time-based media of a message to a recipient as the media is created. The transmit module transmits the message in either a messaging mode where the time-based media of the message is transmitted before a delivery route to the recipient is completely discovered or a call mode where the transmission occurs after providing a notification requesting synchronous communication and receiving a confirmation that the recipient would like to engage in synchronous communication. In response to the notification, the recipient has the option of rendering the incoming message in either a real-time mode as the time-based media of the message is received or a time-shifted mode by rendering the time-based media of the message at an arbitrary later time after it was received. One or more rendering options are also provided to seamlessly transition the rendering of the time-based media of the message between the two modes.

The messaging application is also capable of transmitting and receiving the media of messages at the same time. Consequently, when two (or more) parties are sending messages to each other at approximately the same time, the user experience is similar to a synchronous telephone call. Alternatively, when messages are sent back and forth at discrete times, the user experience is similar to an asynchronous messaging system.

In various embodiments, any of a number of real-time communication protocols may be used. Examples include, but are not limited to, a loss tolerant protocol such as UDP, a network efficient protocol such as TCP, synchronization protocols such as CTP, “progressive” emails, or HTTP. With the latter two examples, modifications are made to each protocol so that message headers are separated from message bodies. The message headers are used to define and transport contact information, message meta data and presence status information, whereas the body of the messages are used to progressively transport the actual media of the messages as the media is created or retrieved from storage.

The messaging application is also capable of supporting either late-binding or early-binding communication. In two non-exclusive late binding embodiments, the message headers of either progressive emails or HTTP messages, are used for route discovery, a soon as an identifier for a recipient is defined, while the time-based media of the message is progressively transmitted within the body of the message as the delivery route to the recipient is discovered. Alternatively with early-binding embodiments, the Session Internet Protocol (SIP) may be used for setting up and tearing down communication sessions between client communication devices 12 over the network 14.

The communication application solves many of the problems associated with conventional telephony and voice mail, regardless if conducted over the PSTN or VoIP. With the storage of transmitted and received media, late-binding and the various rendering options, conversation participants may elect to communicate with each other either synchronously or asynchronously. A recipient of an incoming message may optionally render the media in the real-time mode, the time-shifted mode and to seamlessly transition between the two modes. Consequently the problems associated current voice mail are avoided.

### BRIEF DESCRIPTION OF THE DRAWINGS

The invention may best be understood by reference to the following description taken in conjunction with the accompanying drawings, which illustrate specific embodiments of the invention.

FIG. 1 is diagram of a non-exclusive embodiment of a communication system embodying the principles of the present invention.

FIG. 2 is a diagram of a non-exclusive embodiment of a communication application embodying the principles of the present invention.

FIG. 3 is an exemplary diagram showing the flow of media on a communication device running the communication application in accordance with the principles of the invention.

FIGS. 4A through 4H illustrate a series of exemplary user interface screens illustrating various features and attributes of the communication application when transmitting media in accordance with the principles of the invention.

FIGS. 5A through 5C illustrate a series of exemplary user interface screens illustrating various features and attributes of the communication application when receiving media in accordance with the principles of the invention.

FIGS. 6A through 6C illustrate a series of exemplary user interface screens illustrating various features and attributes of the communication application when transmitting media after a network disruption in accordance with the principles of the invention.

FIGS. 7A through 7C illustrate the structure of individual message units used by the communication application in accordance with the principles of the present invention.

It should be noted that like reference numbers refer to like elements in the figures.

The above-listed figures are illustrative and are provided as merely examples of embodiments for implementing the various principles and features of the present invention. It should be understood that the features and principles of the present invention may be implemented in a variety of other embodiments and the specific embodiments as illustrated in the Figures should in no way be construed as limiting the scope of the invention.

### DETAILED DESCRIPTION OF SPECIFIC EMBODIMENTS

The invention will now be described in detail with reference to various embodiments thereof as illustrated in the accompanying drawings. In the following description, specific details are set forth in order to provide a thorough understanding of the invention. It will be apparent, however, to one skilled in the art, that the invention may be practiced without using some of the implementation details set forth herein. It should also be understood that well known operations have not been described in detail in order to not unnecessarily obscure the invention.

### Media, Messages and Conversations

“Media” as used herein is intended to broadly mean virtually any type of media, such as but not limited to, voice, video, text, still pictures, sensor data, GPS data, or just about any other type of media, data or information. Time-based media is intended to mean any type of media that changes over time, such as voice or video. By way of comparison, media such as text or a photo, is not time-based since this type of media does not change over time.

As used herein, the term “conversation” is also broadly construed. In one embodiment, a conversation is intended to mean a one or more of messages, strung together by some common attribute, such as a subject matter or topic, by name, by participants, by a user group, or some other defined criteria. In another embodiment, the one or more messages of a conversation do not necessarily have to be tied together by some common attribute. Rather, one or more messages may be arbitrarily assembled into a conversation. Thus, a conversation is intended to mean two or more messages, regardless if they are tied together by a common attribute or not.

### System Architecture

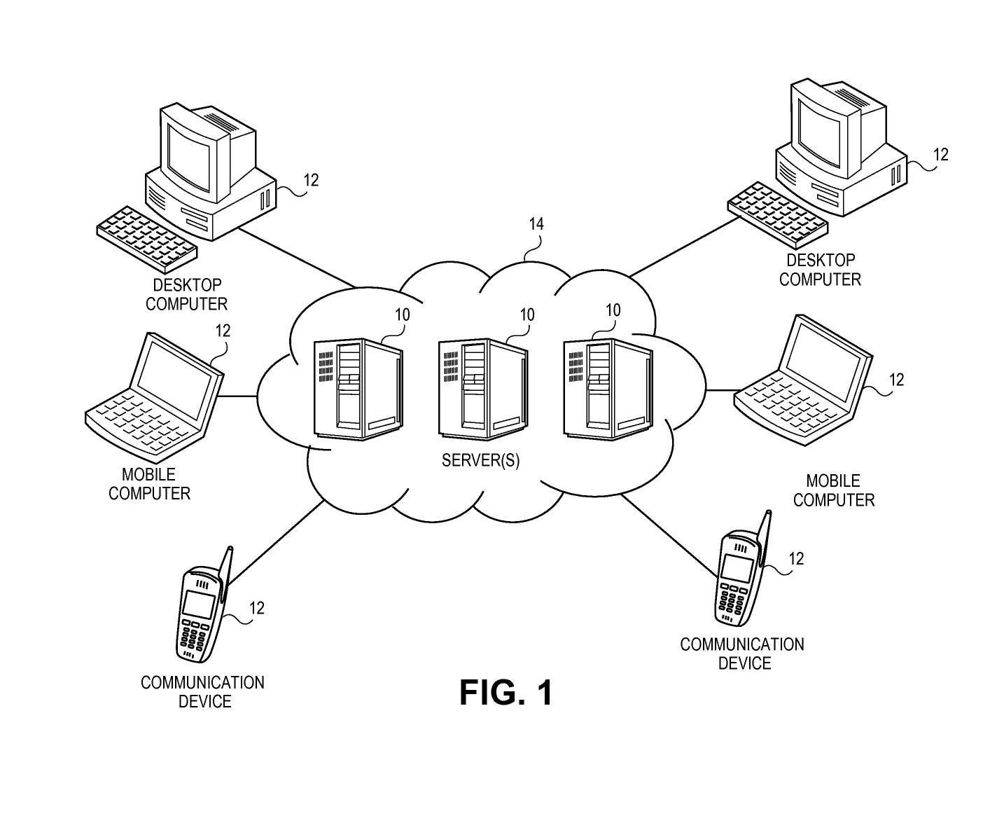

Referring to FIG. 1, an exemplary communication system including one or more communication servers 10 and a plurality of client communication devices 12 is shown. A communication services network 14 is used to interconnect the individual client communication devices 12 through the servers 10.

The server(s) 10 run an application responsible for routing the metadata used to set up and support conversations as well as the actual media of messages of the conversations between the different client communication devices 12. In one specific embodiment, the application is the server application described in commonly assigned co-pending U.S. application Ser. Nos. 12/028,400 (U.S Patent Publication No. 2009/0003558), 12/192,890 (U.S Patent Publication No. 2009/0103521), and 12/253,833 (U.S Patent Publication No. 2009/0168760), each incorporated by reference herein for all purposes.

The client communication devices 12 may be a wide variety of different types of communication devices, such as desktop computers, mobile or laptop computers, e-readers such as the iPad® by Apple, the Kindle® from Amazon, etc., mobile or cellular phones, Push To Talk (PTT) devices, PTT over Cellular (PoC) devices, radios, satellite phones or radios, VoIP phones, WiFi enabled devices such as the iPod® by Apple, or conventional telephones designed for use over the Public Switched Telephone Network (PSTN). The above list should be construed as exemplary and should not be considered as exhaustive or limiting. Any type of communication device may be used.

The communication services network 14 is IP based and layered over one or more communication networks (not illustrated), such as Public Switched Telephone Network (PSTN), a cellular network based on CDMA or GSM for example, the Internet, a WiFi network, an intranet or private communication network, a tactical radio network, or any other communication network, or any combination thereof. The client communication devices 12 are coupled to the communication services network 14 through any of the above types of networks or a combination thereof. Depending on the type of communication device 12, the connection is either wired (e.g., Ethernet) or wireless (e.g., Wi-Fi, a PTT, satellite, cellular or mobile phone). In various embodiments, the communication services network 14 is either heterogeneous or homogeneous.

### The Communication Application

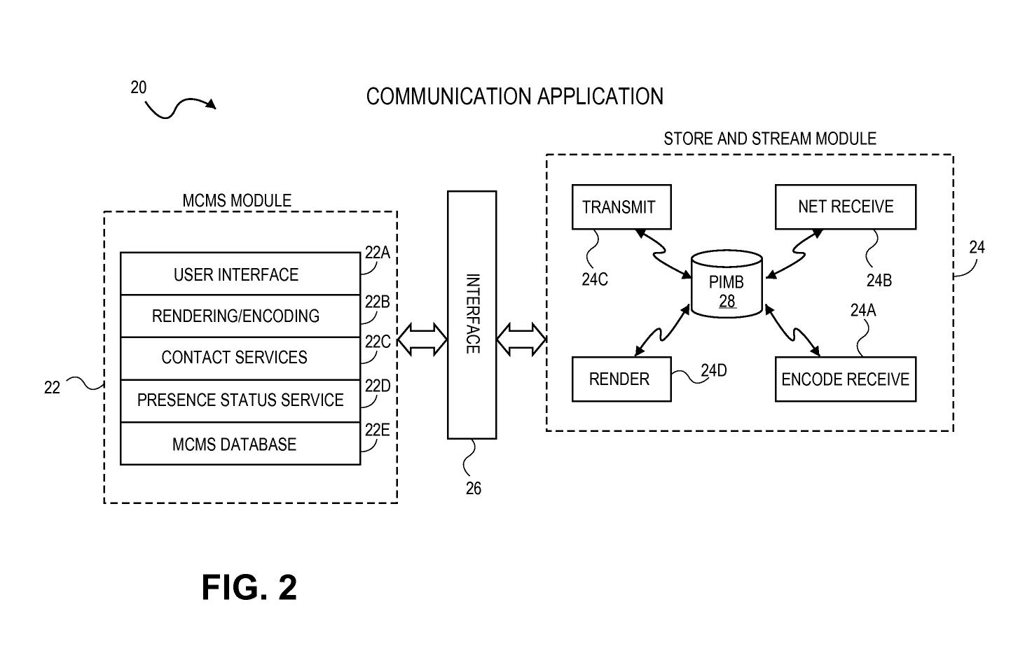

Referring to FIG. 2, a block diagram a communication application 20, which runs on client communication devices 12 is illustrated. The communication application 20 includes a Multiple Conversation Management System (MCMS) module 22, a Store and Stream module 24, and an interface 26 provided between the two modules. The key features and elements of the communication application 20 are briefly described below. For a more detailed explanation, see U.S. application Ser. Nos. 12/028,400, 12/253,833, 12/192,890, and 12/253,820 (U.S Patent Publication No. 2009/0168759), all incorporated by reference herein.

The MCMS module 22 includes a number of modules and services for creating, managing, and conducting multiple conversations. The MCMS module 22 includes a user interface module 22A for supporting the audio and video functions on the client communication device 12, rendering/encoding module 22B for performing rendering and encoding tasks, a contacts service module 22C for managing and maintaining information needed for creating and maintaining contact lists (e.g., telephone numbers, email addresses or other identifiers), and a presence status service module 22D for sharing the online status of the user of the client communication device 12 and which indicates the online status of the other users. The MCMS database 22E stores and manages the metadata for conversations conducted using the client communication device 12.

The Store and Stream module 24 includes a Persistent Infinite Memory Buffer or PIMB 28 for storing, in a time-indexed format, the time-based media of received and sent messages. The Store and Stream module 24 also includes four modules including encode receive 24A, transmit 24C, net receive 24B and render 24D. The function of each module is described below.

The encode receive module 24A performs the function of progressively encoding and persistently storing in the PIMB 28, in the time-indexed format, the media of messages created using the client communication device 12 as the media is created.

The transmit module 24C progressively transmits the media of messages created using the client communication device 12 to other recipients over the network 14 as the media is created and progressively stored in the PIMB 28.

Encode receive module 24A and the transmit module 24C typically, but not always, perform their respective functions at approximately the same time. For example, as a person speaks into their client communication device 12 during a message, the voice media is progressively encoded, persistently stored in the PIMB 28 and transmitted, as the voice media is created.

The net receive module 24B is responsible for progressively storing the media of messages received from others in the PIMB 28 in a time-indexed format as the media is received.

The render module 24D enables the rendering of media either in a near real-time mode or in the time-shifted mode. In the real-time mode, the render module 24D encodes and drives a rendering device as the media of a message is received and stored by the net received module 24B. In the time-shifted mode, the render module 24D retrieves, encodes, and drives the rendering of the media of a previously received message that was stored in the PIMB. In the time-shifted mode, the rendered media could be either received media, transmitted media, or both received and transmitted media.

In certain implementations, the PIMB 28 may not be physically large enough to indefinitely store all of the media transmitted and received by a user. The PIMB 28 is therefore configured like a cache, and stores only the most relevant media, while a PIMB located on a server 10 acts as main storage. As physical space in the memory used for the PIMB 28 runs out, select media stored in the PIMB 28 on the client 12 may be replaced using any well-known algorithm, such as least recently used or first-in, first-out. In the event the user wishes to review or transmit replaced media, then the media is progressively retrieved from the server 10 and locally stored in the PIMB 28. The retrieved media is also progressively rendered and/or transmitted as it is received. The retrieval time is ideally minimal so as to be transparent to the user.

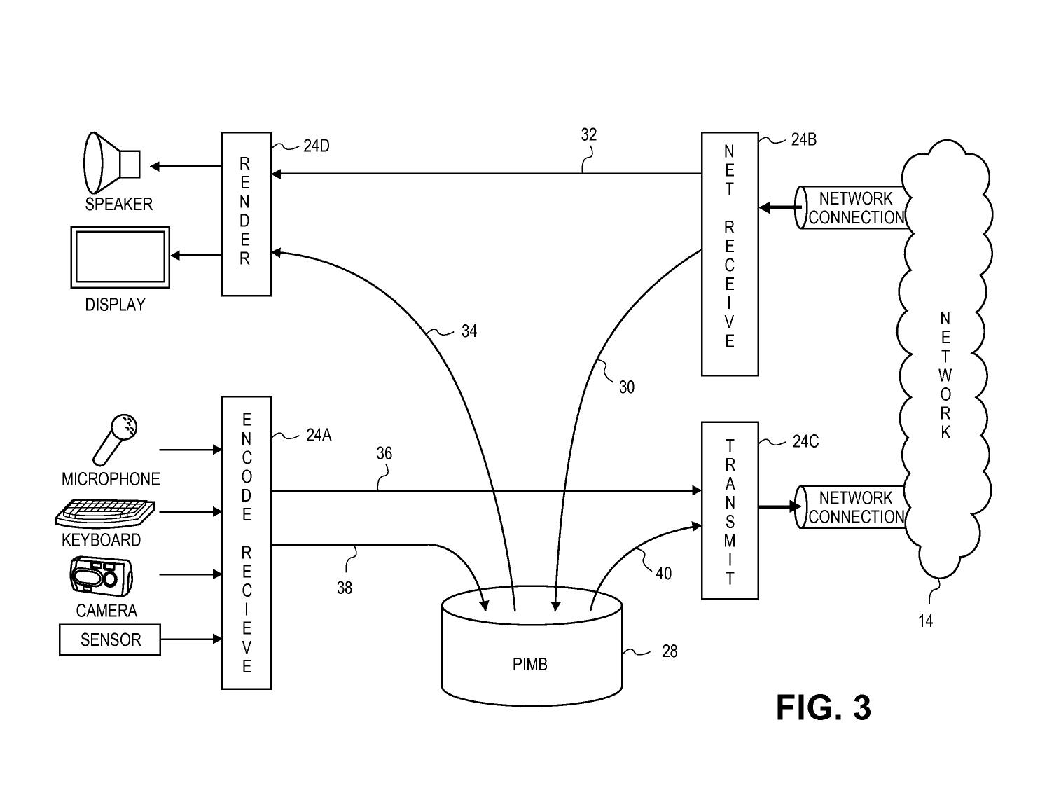

Referring to FIG. 3, a media flow diagram on a communication device 12 running the client application 20 in accordance with the principles of the invention is shown. The diagram illustrates the flow of both the transmission and receipt of media, each in either the real-time mode or the time-shifted mode.

Media received from the communication services network 14 is progressively stored in the PIMB 28 by the net receive module 24B as the media is received, as designated by arrow 30, regardless if the media is to be rendered in real-time or in the time-shifted mode. When in the real-time mode, the media is also progressively provided by the render module 24D, as designed by arrow 32. In the time-shifted mode, the user selects one or more messages to be rendered. In response, the render module 24D retrieves the media of the selected message(s) from the PIMB 28, as designated by arrow 34. In this manner, the recipient may review previously received messages at any arbitrary time in the time-shifted mode.

In most situations, media is transmitted progressively as it is created using a media-creating device (e.g. a microphone, keyboard, video and/or still camera, a sensor such as temperature or GPS, or any combination thereof). As the media is created, it is progressively encoded by encode receive module 24A and then progressively transmitted by transmit module 24C over the network as designed by arrow 36 and progressively stored in the PIMB 28 as designated by arrow 38.

In certain situations, media may be transmitted by transmit module 24C out of the PIMB 28 at some arbitrary time after it was created, as designated by arrow 40. Transmissions out of the PIMB 28 typically occur when media is created while a communication device 12 is disconnected from the network 14. When the device 12 reconnects, the media is progressively read from the PIMB 28 and transmitted by the transmit module 24C.

With conventional “live” communication systems, media is transient, meaning media is temporarily buffered until it is either transmitted or rendered. After being either transmitted or rendered, the media is typically not stored and is irretrievably lost.

With the application 20 on the other hand, transmitted and received media is persistently stored in the PIMB 28 for later retrieval and rendering in the time-shifted mode. In various embodiments, media may be persistently stored indefinitely, or periodically deleted from the PIMB 28 using any one of a variety of known deletion policies. Thus the duration of persistent storage may vary. Consequently, as used herein, the term persistent storage is intended to be broadly construed and mean the storage of media and meta data from indefinitely to any period of time longer than transient storage needed to either transmit or render media in real-time.

As a clarification, the media creating devices (e.g., microphone, camera, keyboard, etc.) and media rendering devices as illustrated are intended to be symbolic. It should be understood such devices are typically embedded in certain devices 12, such as mobile or cellular phones, radios, mobile computers, etc. With other types of communication devices 12, such as desktop computers, the media rendering or generating devices may be either embedded in or plug-in accessories.

### Operation of the Communication Application

The client application 20 is a messaging application that that allows users to transmit and receive messages. With the persistent storage of received messages, and various rendering options, a recipient has the ability to render incoming messages either in real-time as the message is received or in a time-shifted mode by rendering the message out of storage. The rendering options also provide the ability to seamlessly shift the rendering of a received message between the two modes.

The application 20 is also capable of transmitting and receiving the media of messages at the same time. Consequently, when two (or more) parties are sending messages to each other at approximately the same time, the user experience is similar to a synchronous, full-duplex, telephone call. Alternatively, when messages are sent back and forth at discrete times, the user experience is similar to an asynchronous, half-duplex, messaging system.

The application 20 is also capable of progressively transmitting the media of a previously created message out of the PIMB 28. With previously created messages, the media is transmitted in real-time as it is retrieved from the PIMB 28. Thus, the rendering of messages in the real-time may or may not be live, depending on if the media is being transmitted as it is created, or if was previously created and transmitted out of storage.

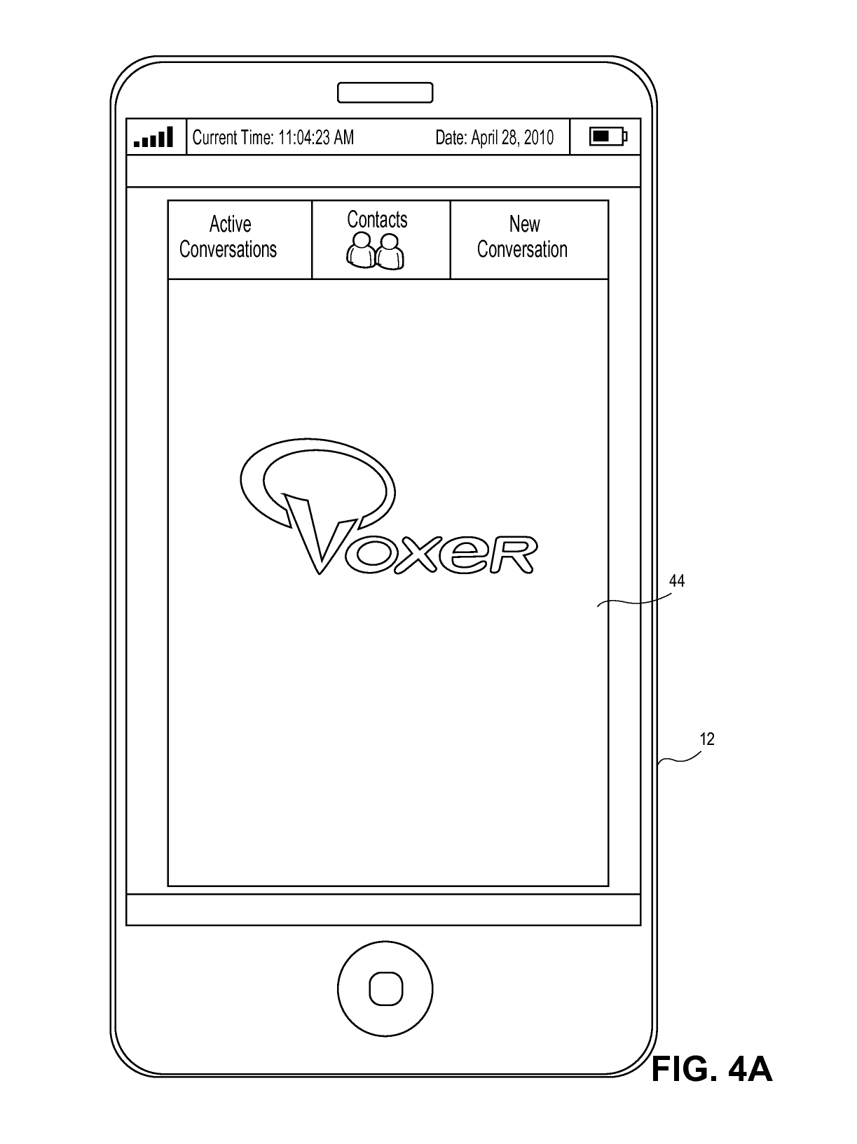

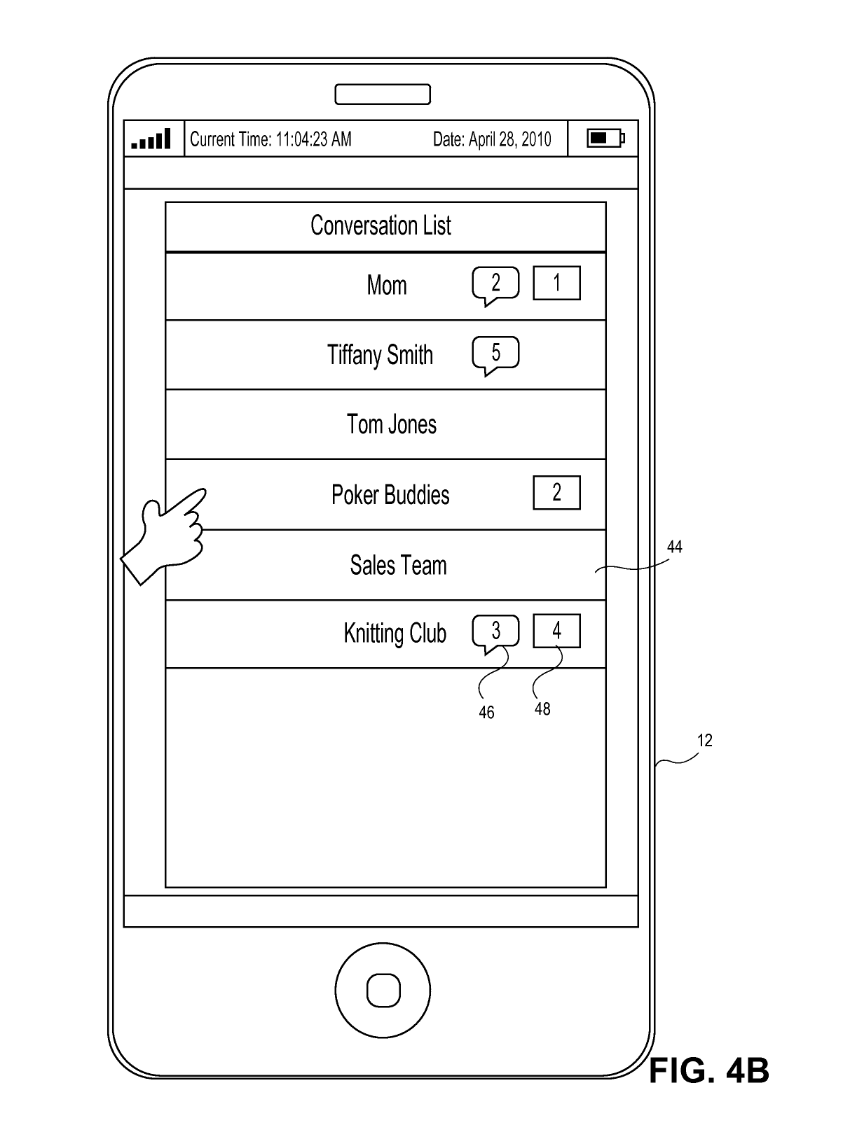

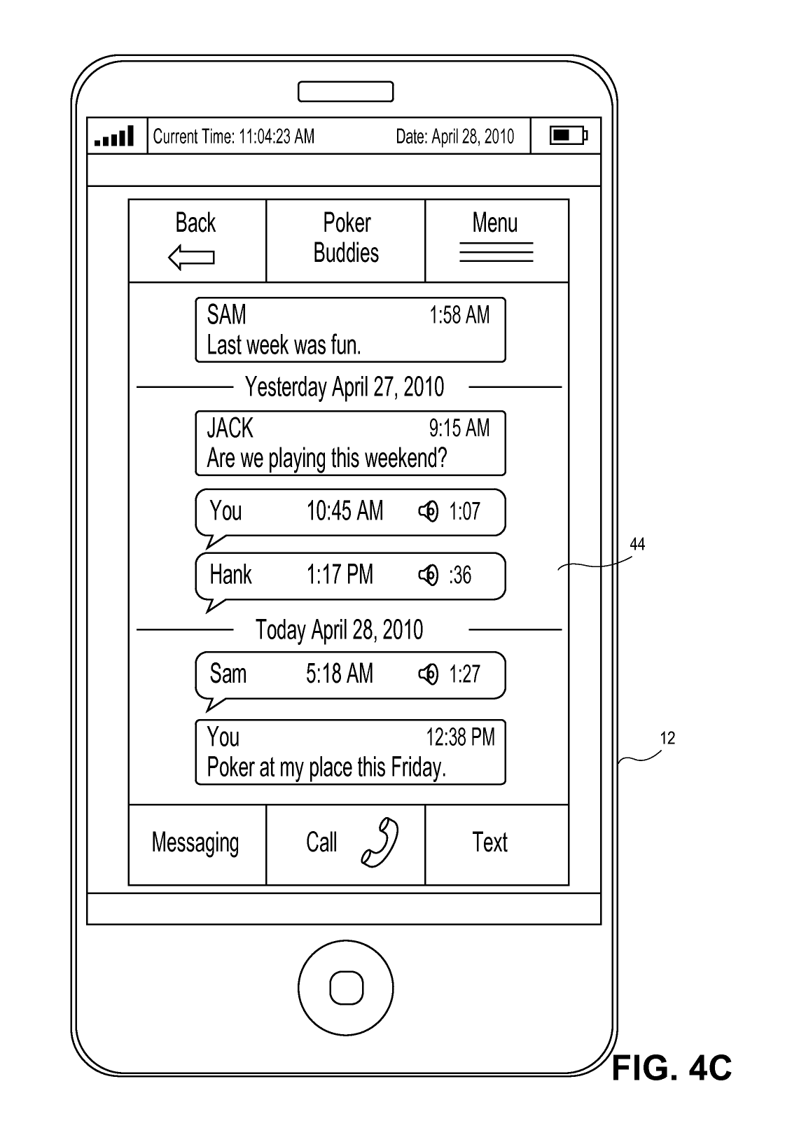

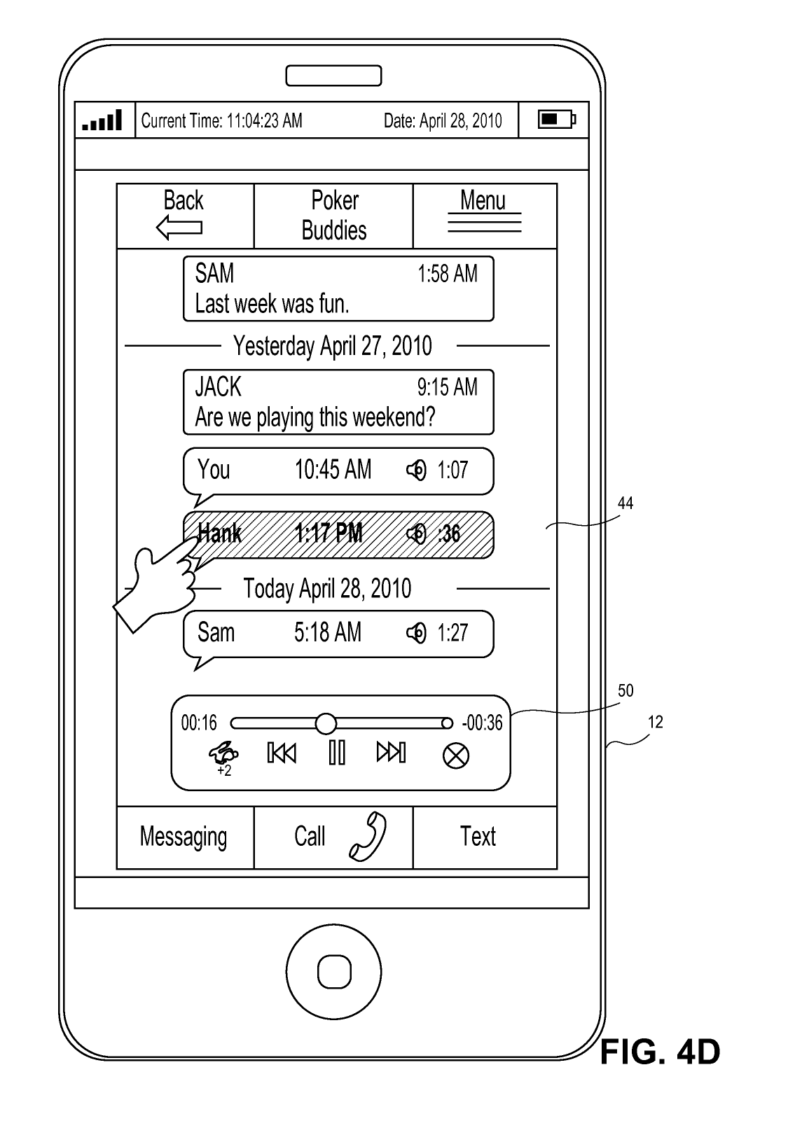

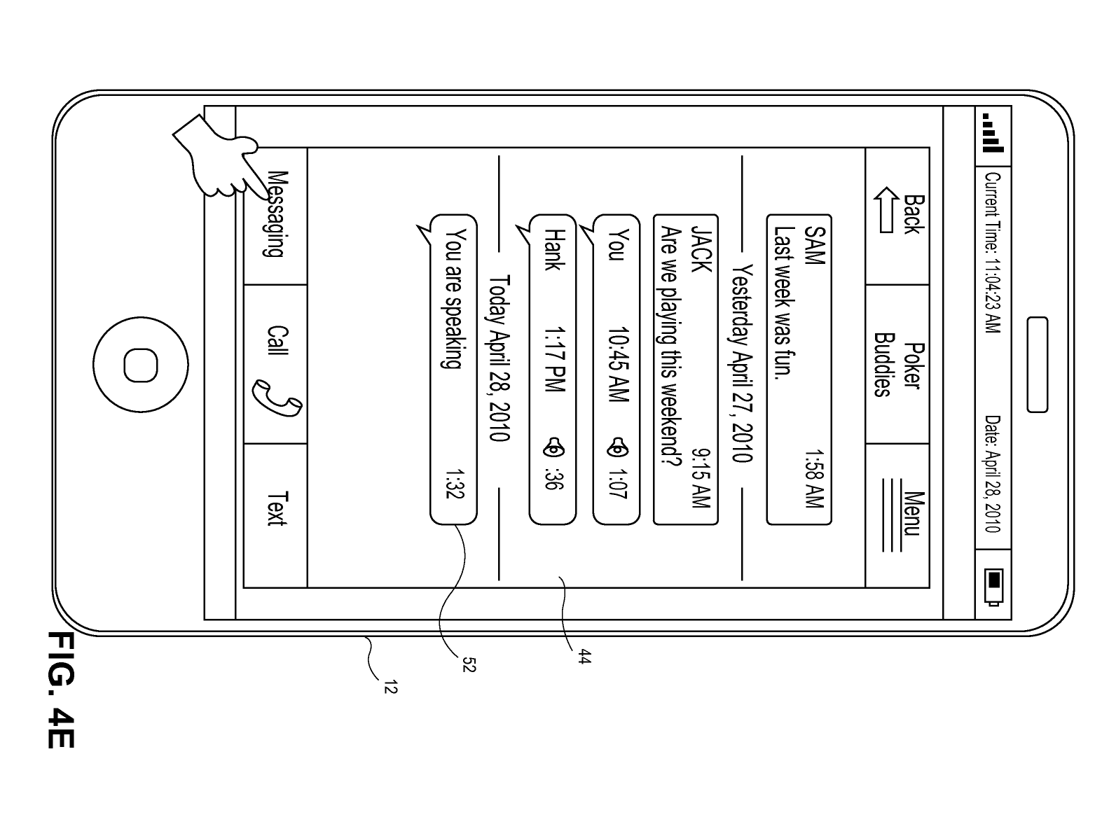

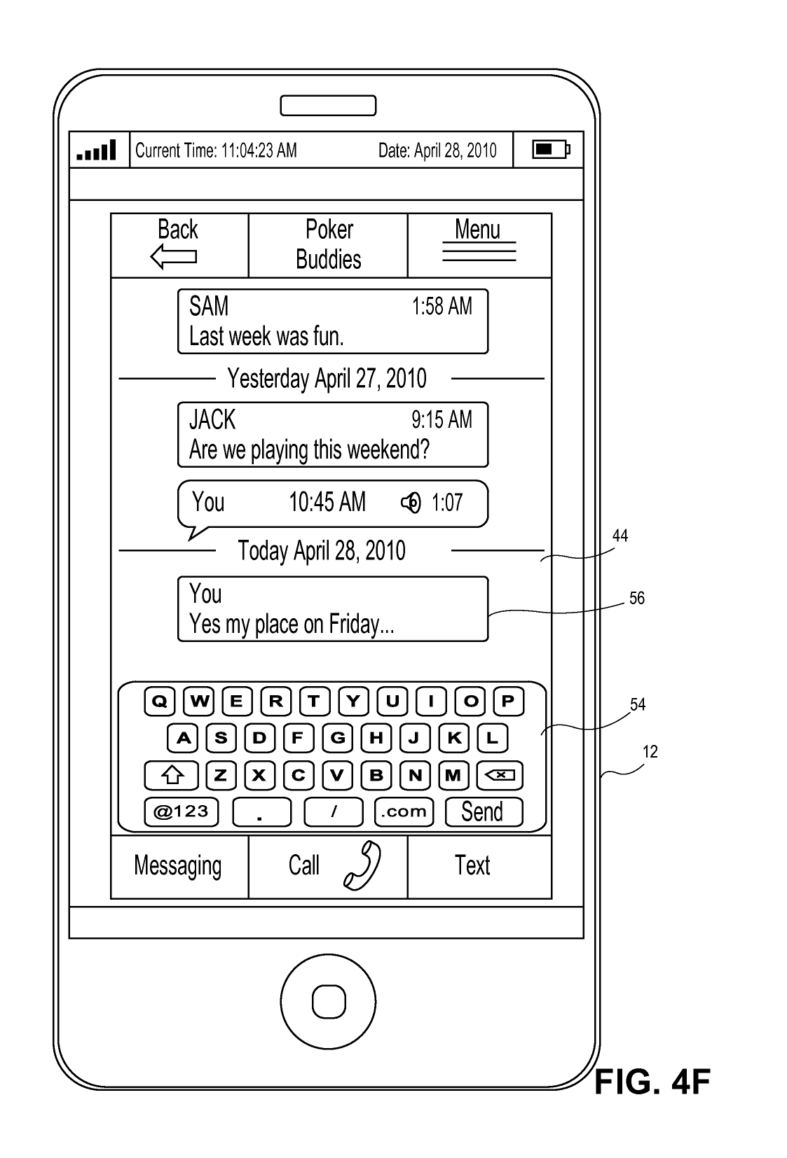

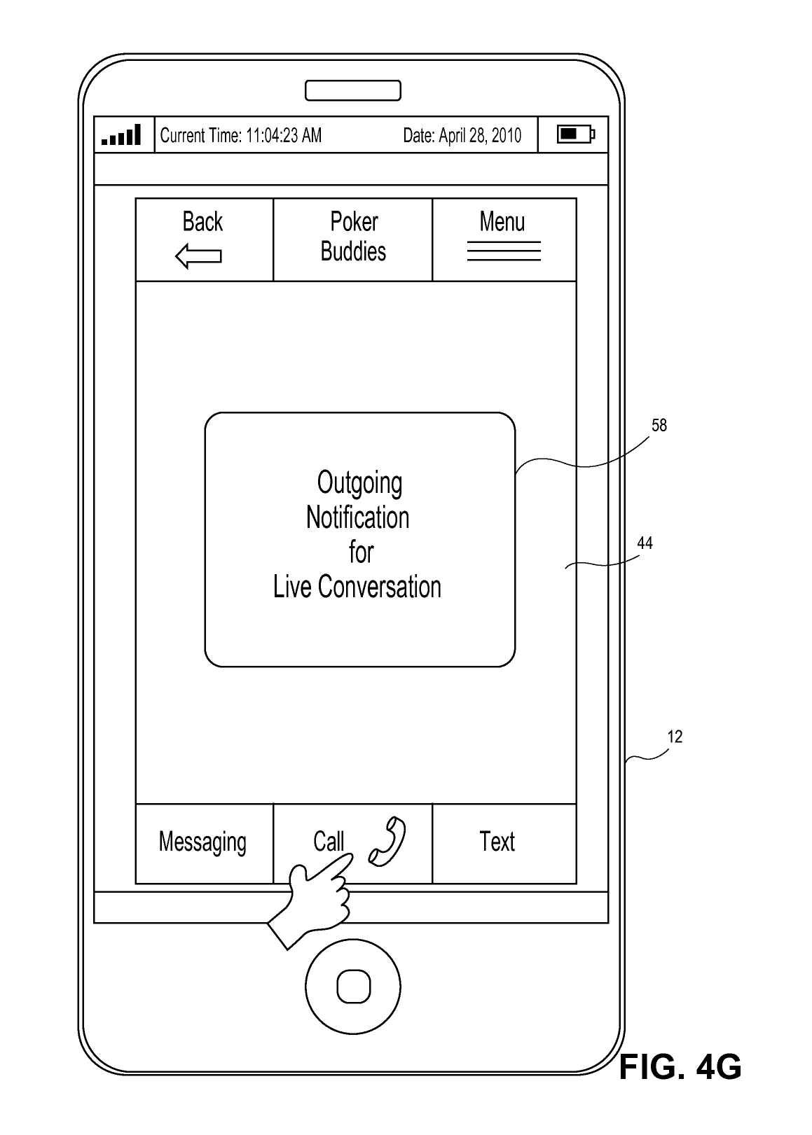

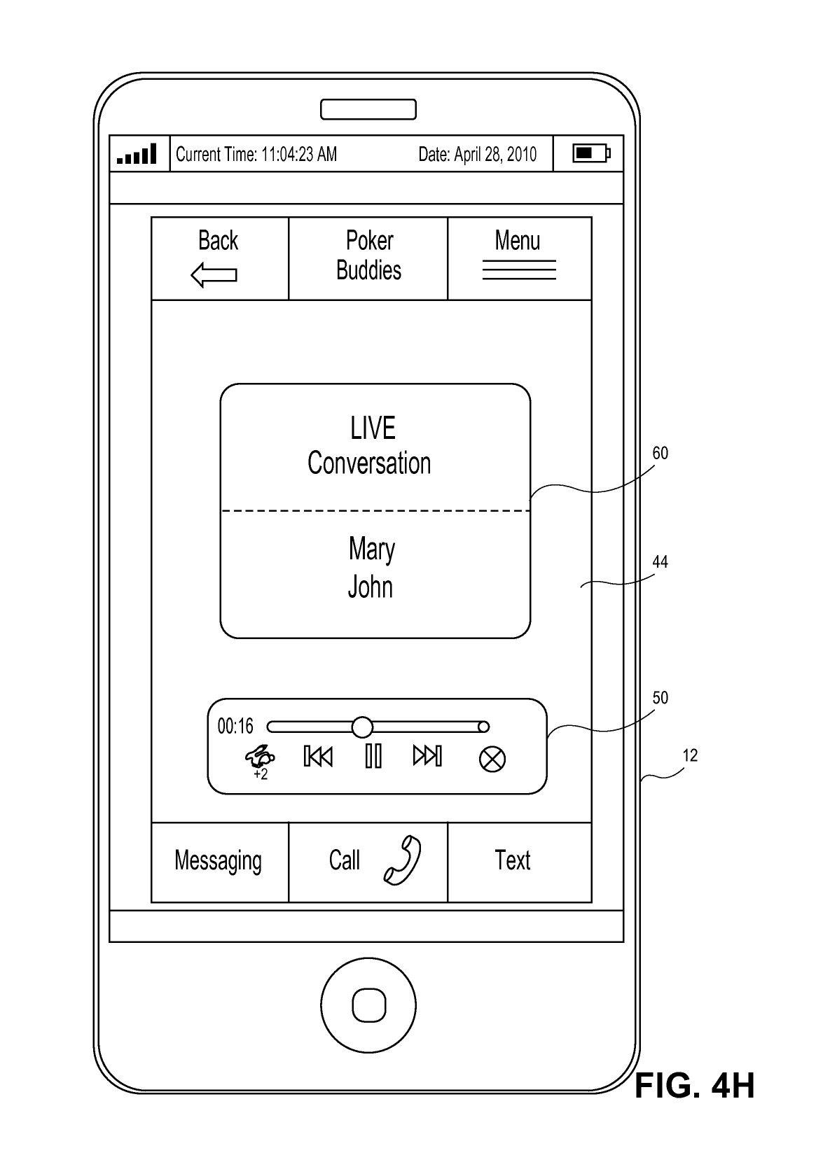

Referring to FIGS. 4A through 4G, a series of exemplary user interface screens appearing on the display 44 on a mobile communication device 12 are illustrated. The user interface screens provided in FIGS. 4A through 4G are useful for describing various features and attributes of the application 20 when transmitting media to other participants of a conversation.

Referring to FIG. 4A, an exemplary home screen appearing on the display 44 of a mobile communication device 12 running the application 20 is shown. In this example, the application 20 is the Voxer™ communication application owned by the assignee of the present application. The home screen provides icons for “Contacts” management, creating a “New Conversation,” and a list of “Active Conversations.” When the Contacts icon is selected, the user of the device 12 may add, delete or update their contacts list. When the Active Conversations input is selected, a list of the active conversations of the user appears on the display 44. When the New Conversation icon is selected, the user may define the participants and a name for a new conversation, which is then added to the active conversation list.

Referring to FIG. 4B, an exemplary list of active conversations is provided in the display 44 after the user selects the Active Conversations icon. In this example, the user has a total of six active conversations, including three conversations with individuals (Mom, Tiffany Smith and Tom Jones) and three with user groups (Poker Buddies, Sales Team and Knitting Club).

Any voice messages or text messages that have not yet been reviewed for a particular conversation appear in a voice media bubble 46 or text media rectangle 48 appearing next to the conversation name respectively. With the Knitting Club conversation for example, the user of the device 12 has not yet reviewed three (3) voice messages and four (4) text messages.

As illustrated in FIG. 4C, the message history of a selected conversation appears on the display 44 when one of the conversations is selected, as designated by the hand selecting the Poker Buddies conversation. The message history includes a number of media bubbles displayed in the time-index order in which they were created. The media bubbles for text messages include the name of the participant that created message, the actual text message (or a portion thereof) and the date/time it was sent. The media bubbles for voice messages include the name of the participant that created the message, the duration of the message, and the date/time it was sent.

When any bubble is selected, the corresponding media is retrieved from the PIMB 28 and rendered on the device 12. With text bubbles, the entire text message is rendered on the display 44. With voice and/or video bubbles, the media is rendered by the speakers and/or on the display 44.

The user also has the ability to scroll up and/or down through all the media bubbles of the selected conversation. By doing so, the user may select and review any of the messages of the conversation at any arbitrary time in the time-shifted mode. Different user-interface techniques, such as shading or using different colors, bolding, etc., may also be used to contrast messages that have previously been reviewed with messages that have not yet been reviewed.

Referring to FIG. 4D, an exemplary user interface on display 44 is shown after the selection of a voice media bubble. In this example, a voice message by a participant named Hank is selected. With the selection, a media rendering control window 50 appears on the display 44. The render control window 50 includes a number of rendering control options, as described in more detail below, that allow the user of the device 12 to control the rendering of the media contained in the message from Hank.

The user of device 12 is presented with three options for contributing media to a selected conversation. The choices include Messaging, Call, or Text. In the example illustrated in FIGS. 4C and 4D, icons for each are provided at the bottom of the display.

With the Messaging or Text options, the intent of the user is to send either an asynchronous voice or text message to the other participants of the conversation. With the Call option, however, the intent of the user is to engage in synchronous, communication with one or more other participants of the conversation.

FIG. 4E illustrates an exemplary user interface when the Messaging option is selected. With this selection, a media bubble 52 indicating that the user of device 12 is contributing a voice message to the conversation appears in time-index order on the display 44. The time-duration of the message is also displayed within the media bubble 52. As the media of the media is created, the media is progressively sent to the other participants of the conversation. The procedure for indicating the start and end of the asynchronous message may vary depending on implementation details.

In one embodiment, as illustrated, the Messaging icon operates similar to a Push To Talk (PTT) radio, where the user selects and holds the icon while speaking. When done, the user releases the icon, signifying the end of the message. In a second embodiment (not illustrated), Start and Stop icons may appear in the user interface on display 44. To begin a message, the Start icon is selected and the user begins speaking. When done, the Stop icon is selected. In a third embodiment, which is essentially a combination of the previous two, the Messaging icon is selected a first time to begin the message, and then selected a second time to end the message. This embodiment differs from the first “PTT” embodiment because the user is not required to hold the Messaging icon for the duration of the message. Regardless of which embodiment is used, the media of the outgoing message is progressively stored in the PIMB 28 and transmitted to the other participants of the Poker Buddies conversation as the media is created.

With the Messaging option, the sender has the option of either preventing or allowing a recipient from joining a live conversation in response to the message. Embodiments where the recipient is prevented from joining the conversation live may be implemented in a variety of different ways. For example, the recipient may not receive a notification that a message was received until the message was received in full. Alternatively, a join option (as described below) may be deactivated on the recipient(s) devices 12. In other situations, the sender may not care if a recipient elects to join a live session in response to the message. In the latter case, the recipient(s) are notified that of the incoming message and may elect to join the conversation live.

FIG. 4F illustrates an exemplary user interface when the Text option is selected. With this option, a keyboard 54 appears on the user interface on display 44. As the user types the text message, it appears in a text media bubble 56. When the message is complete, it is transmitted to the other participants by the “Send” function on the keyboard 54. In other types of communication devices 12 having a built-in keyboard or a peripheral keyboard, a keyboard 54 will typically not appear on the display 44 as illustrated. Regardless of how the keyboard function is implemented, the media bubble including the text message is included in the conversation history in time-indexed order after it is transmitted.

FIG. 4G shows an exemplary user interface appearing on display 44 when the Call option is selected. With this option, a notification window 58 appears on the display 44 for a predetermined period of time. During this period, the other participants of the conversation are notified that the user of device 12 wishes to engage in live communication, similar to a conventional telephone conversation. The notification may be an audio notification, such as a ring tone, a visual notification, such as a visual indicator appearing on the display of the communication devices 12 of the other participants, or a combination of the two.

FIG. 4H illustrates an exemplary user interface during live communication. In this example, a window 60 appears on the display indicating that Mary and John have responded to the notification and have joined the conversation live. Consequently Mary, John and the user of the device 12 may engage in synchronous, full duplex, communication. As each participant speaks and contributes media to the conversation, media bubbles are created and added in time-index order to the conversation history. In this manner, all the participants of the conversation, regardless if they participate in the live session or not, may review the exchanged media at any arbitrary later time in the time-shifted mode.

In an optional embodiment, the media rendering control window 50 may also appear in the display 44 during a live session as illustrated in FIG. 4H. The window 50 provides the user of device 12 with various rendering options as described in detail below.

In the event none of the other participants of the conversation join the conversation live, then the sender may elect to leave an asynchronous message. In one embodiment, the sender is required to select the Messaging icon before a message can be left. In an alternative embodiment, the sender may leave a message with the Call option after none of the other participants join the conversation after a predetermined period of time. Regardless of how left, each of the participants of the Poker Buddies conversation can then review the message at an arbitrary later time of their choosing respectively.

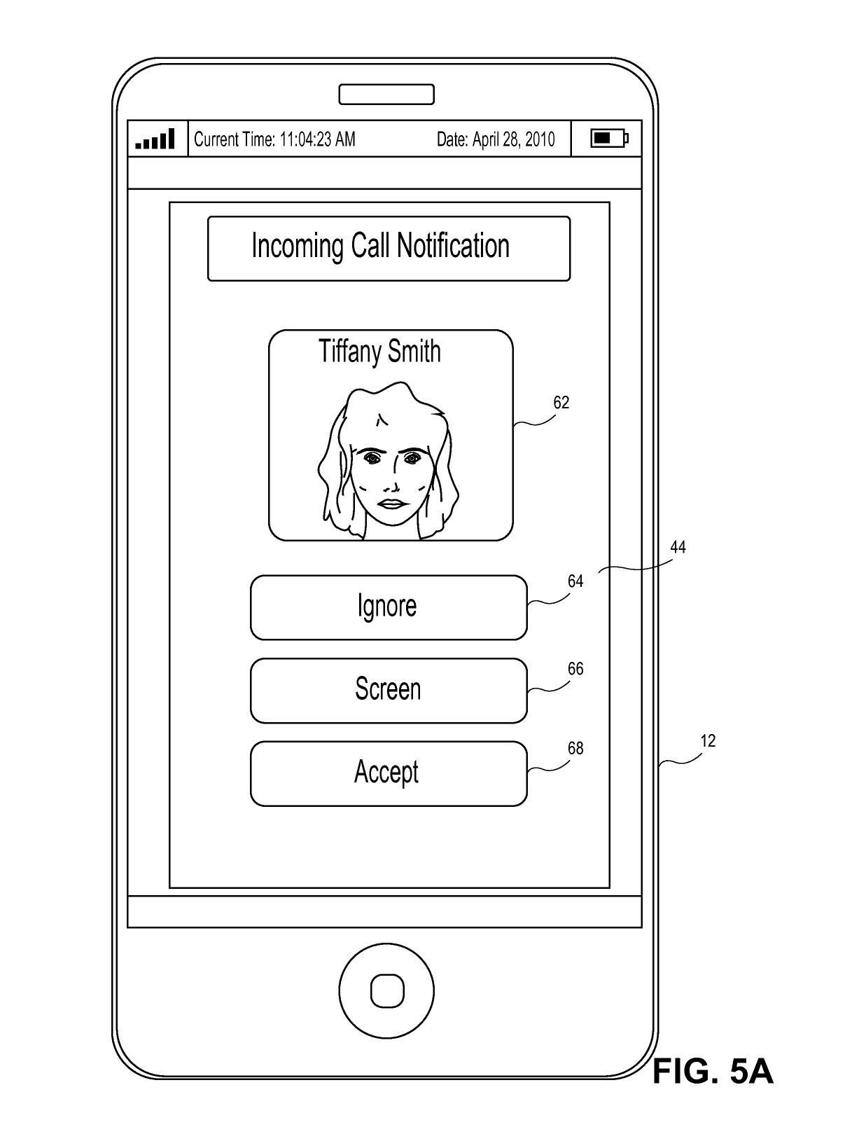

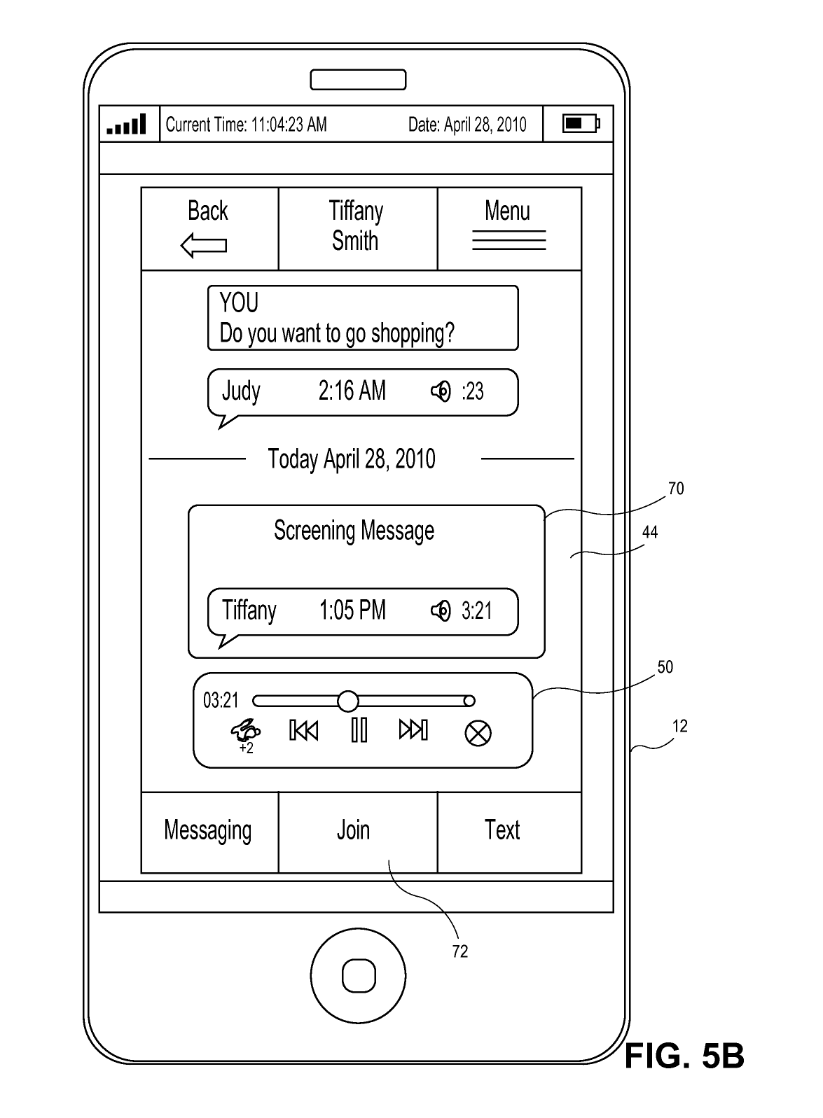

Referring to FIGS. 5A through 5C, a series of user interface screens appearing on the display 44 on a mobile communication device 12 are illustrated. The user interface screens provided in FIGS. 5A through 5C are useful in describing various features and attributes of the application 20 when receiving media from another participant of a conversation.

FIG. 5A, illustrates an exemplary user interface appearing on display 44 of communication device 12 when a user receives a call notification. In this case, a contact named Tiffany Smith is attempting to speak live to the recipient. The notification optionally includes an avatar 62 showing a picture or image of Tiffany and three response options, including Ignore 64, Screen 66 or Accept 68.

If the notification is ignored, either purposely by selecting the Ignore icon 64, or by default because the recipient is not available when the notification is received, then any message left by the caller is progressively stored in the PIMB 28. The recipient can then review the message at an arbitrary later time in the time-shifted mode.

FIG. 5B illustrates an exemplary user interface appearing on the display 44 when the recipient elects to screen the incoming message. When the Screen option 66 is selected, a media bubble 70 appears on the display 44 showing that Tiffany is in the midst of leaving a message. At the same time, the media of the message is progressively rendered as the media from Tiffany Smith is created, transmitted and received, so that the recipient may listen to the message live. When the screening option is elected, the caller is typically not notified that the recipient is reviewing the message live. Alternatively, the caller could be notified. The recipient also has the option to join the conversation live at any time during the incoming message by selecting the Join icon 72.

FIG. 5C illustrates an exemplary user interface when the recipient elects the Join option 68. When the Join icon 72 is selected, the user interface provides a visual indication that the caller and the recipient are engaged in a synchronous “live” communication.

### Rendering Controls

In various situations, the media rendering control window 50 appears on the display 44, as noted above. The rendering options provided in the window 50 may include, but are not limited to, play, pause, replay, play faster, play slower, jump backward, jump forward, catch up to the most recently received media or Catch up to Live (CTL), or jump to the most recently received media. The latter two rendering options are implemented by the “rabbit” icon, which allows the user to control the rendering of media either faster (e.g., +2, +3. +4) or slower (e.g., −2, −3, −4) than the media was originally encoded. As described in more detail below, the storage of media and certain rendering options allow the participants of a conversation to seamlessly transition the rendering of messages and conversations from a time-shifted mode to the real-time mode and vice versa.

Several examples below highlight the seamless transition between the time-shifted and real-time modes:

(i) consider an example of a recipient receiving an incoming live message. If the recipient does not have their communication device 12 immediately available, for example because their device 12 is in their pocket or purse, then most likely the initial portion of the message will not be heard. But with the CTL rendering option, the recipient can review the previous received portions of the message out of persistent storage at a faster than the media was originally encoded, while the message is still being received. Eventually, the rendering of the media at the increased rate will catch-up to the live point of the message, whereupon, there is a seamless transition from the time-shifted mode to the real-time mode. After the seamless transition occurs, the recipient may continue screening the message live or the recipient may elect the Join option 72 and engage in synchronous communication;

(ii) in another example, a seamless transition may occur from the real-time mode to the time-shifted mode. Consider a person participating in “live” communication with multiple parties (e.g., a conference call). When the “pause” rendering option is selected, the “live” rendering of incoming media stops, thus seamlessly transitioning the participation of the party that selected the pause option from the real-time to time-shifted mode. After the pause, the party may rejoin the conversation “live’, assuming it is still ongoing, in the real-time mode. The “missed” media during the pause may be reviewed at any arbitrary later time in the time-shifted mode from the persistent storage;

(iii) in another example of the seamless transition from real-time to time-shifted, one party may elect to leave a live session while the other party continues speaking. When this situation occurs, the departing party may review the message at any arbitrary later time in the time-shifted mode;

(iv) in another example, a recipient may receive a text message and may respond by electing to speak live with the sender; and

(v) in yet another example, two (or more) participants engaged in synchronous communication may, at any point, end the live discussion and start sending each other either asynchronous voice or text messages.

The above examples provided above are not exhaustive, but rather are meant to be exemplary. Instead, the term seamless transition is intended to mean any transition where the rendering occurs from storage to as the media is received, or vice-versa.

### Transmission Out of Storage

With the persistent storage of transmitted and received media of conversations in the PIMB 28, a number of options for enabling communication when a communication device 12 is disconnected from the network 14 are possible. When a device 12 is disconnected from the network 14, for example when a cell phone roams out of network range, the user can still create messages, which are stored in the PIMB 28. When the device 12 re-connects to the network 14, when roaming back into network range, the messages may be automatically transmitted out of the PIMB 28 to the intended recipient(s). Alternatively, previously received messages may also be reviewed when disconnected from the network, assuming the media is locally stored in the PIMB 28. For more details on these features, see U.S. application Ser. Nos. 12/767,714 and 12/767,730, both filed Apr. 26, 2010, commonly assigned to the assignee of the present application, and both incorporated by reference herein for all purposes.

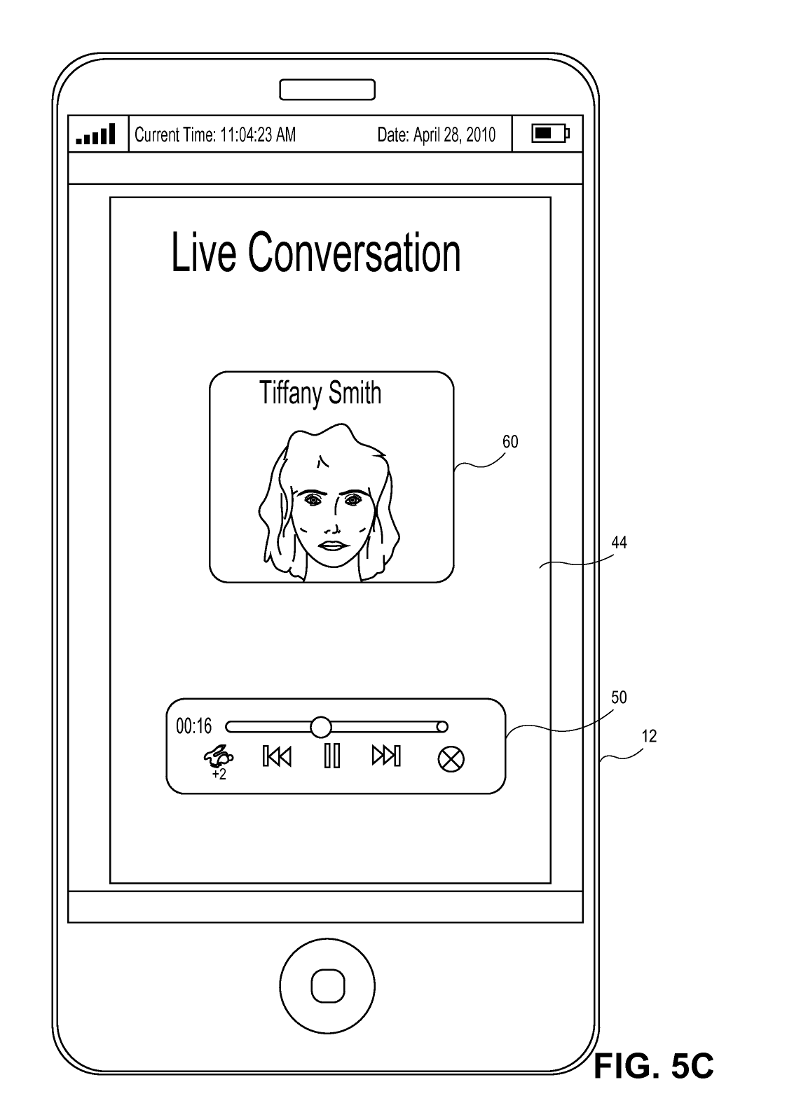

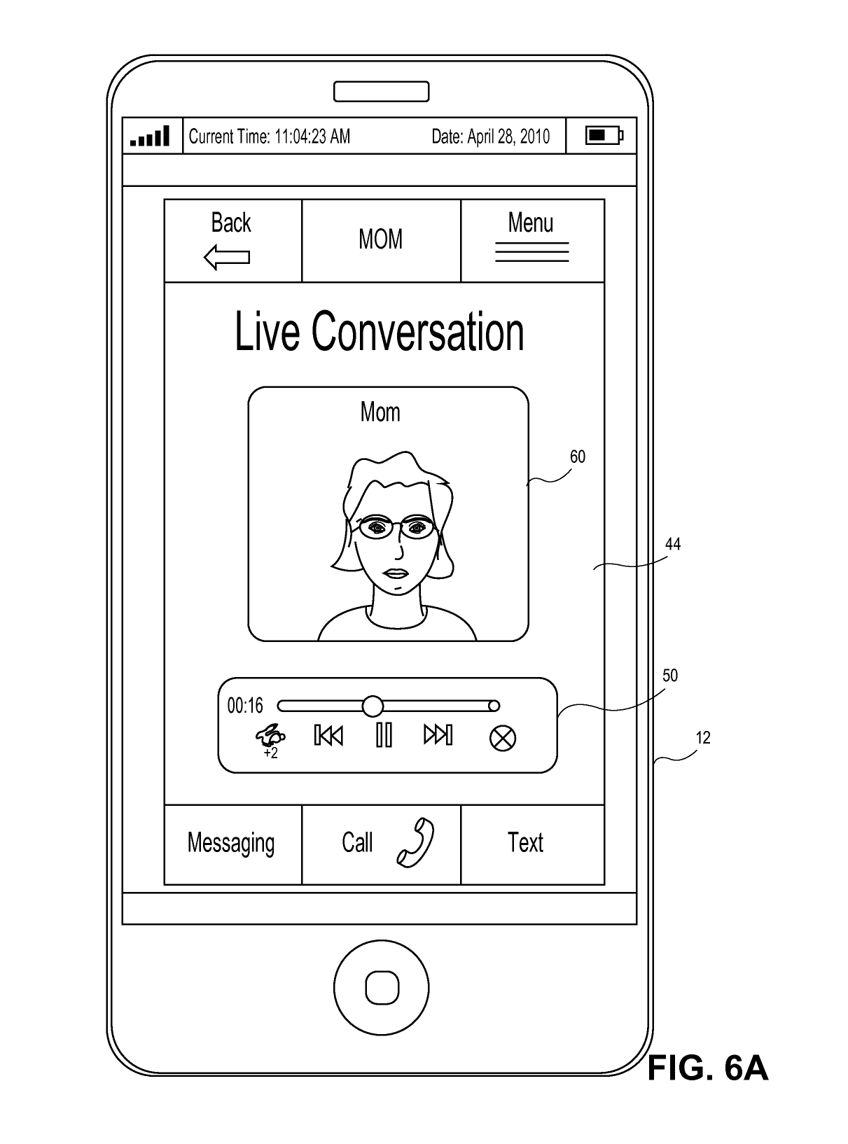

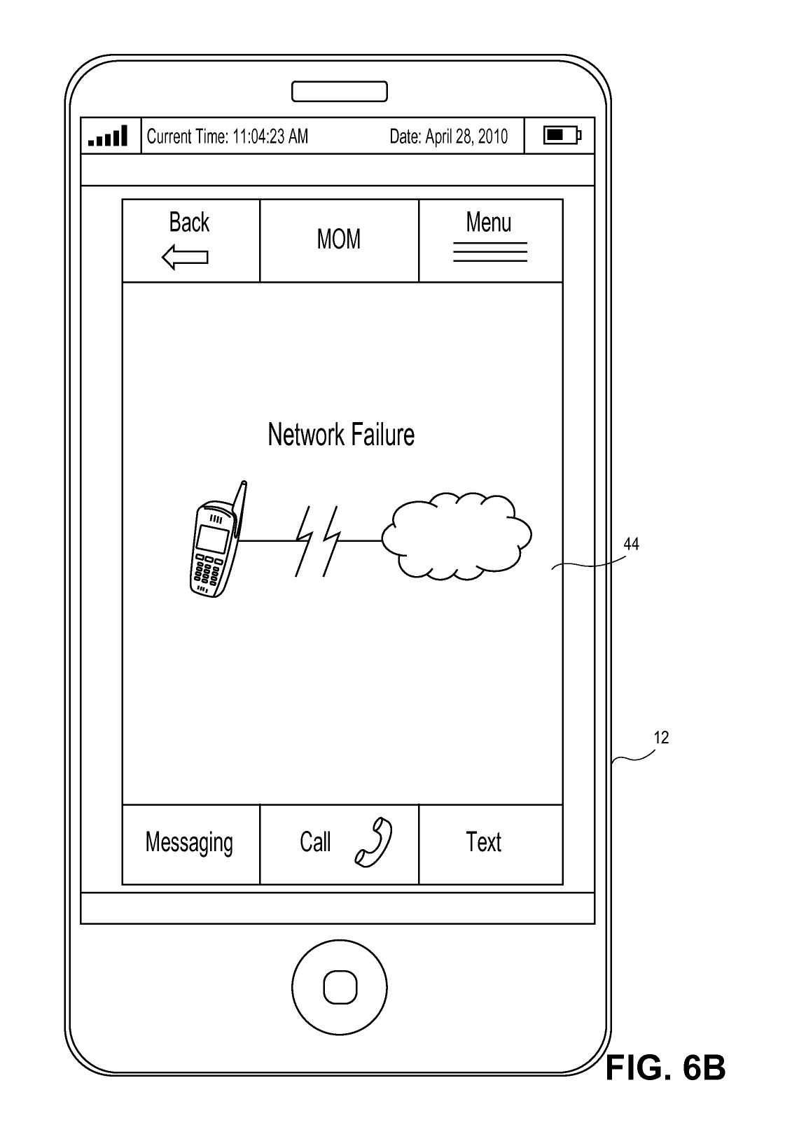

Referring to FIGS. 6A through 6C, a series of user interface screens appearing on the display 44 on a mobile communication device 12 are illustrated for the purpose of describing various features and attributes of the application 20 when transmitting media out of the PIMB 28. FIG. 6A illustrates the user interface appearing on display 44 during a live conversation session with Mom. During the session, the device 12 experiences a network failure. When the failure occurs, a notification appears on the user interface on display 44 notifying the user that they are no longer connected to the network 14, as illustrated in FIG. 6B. When this situation occurs, the user of device 12 has the option of continuing or creating new messages, by selecting either the Messaging or Text icons as provided in FIG. 6C. In this example, the user elects to create a voice message, causing a voice media bubble 52 to appear. When the device 12 reconnects, the media of the message is automatically transmitted to Mom out of the PIMB 28. Multiple voice and/or text messages may be created while off the network and transmitted out of the PIMB 28 in a similar manner. Alternatively, as noted above, the user of device 12 may review the media of messages locally stored in the PIMB 28 when disconnected from the network 14.

It should be noted that the look and feel of the user interface screens illustrated in FIGS. 4A-4H, 5A-5C and 6A and 6C are merely exemplary and have been used to illustrate certain operations characteristic of the application 20. In no way should these examples be construed as limiting. In addition, the various conversations used above as examples primarily included voice media and/or text media. It should be understood that conversations may also include other types of media, such a video, audio, GPS or sensor data, etc. It should also be understood that certain types of media may be translated, transcribed or otherwise processed. For example, a voice message in English may be translated into another language or transcribed into text, or vice versa. GPS information can be used to generated maps or raw sensor data can be tabulated into tables or charts for example.

### Real-Time Communication Protocols

In various embodiments, the communication application 20 may rely on a number of real-time communication protocols. In one optional embodiment, a combination of a loss tolerant (e.g., UDP) and a network efficient protocol (e.g., TCP) are used. The loss tolerant protocol is used only when transmitting time-based media that is being consumed in real-time and the conditions on the network are inadequate to support a transmission rate sufficient to support the real-time consumption of the media using the network efficient protocol. On the other hand, the network efficient protocol is used when (i) network conditions are good enough for real-time consumption or (ii) for the retransmission of missing or all of the time-based media previously sent using the loss tolerant protocol. With the retransmission, both sending and receiving devices maintain synchronized or complete copies of the media of transmitted and received messages in the PIMB 28 on each device 12 respectively. For details regarding this embodiment, see U.S. application Ser. Nos. 12/792,680 and 12/792,668 both filed on Jun. 2, 2010 and both incorporated by reference herein.

In another optional embodiment, the Cooperative Transmission Protocol (CTP) for near real-time communication is used, as described in U.S. application Ser. Nos. 12/192,890 and 12/192,899 (U.S Patent Publication Nos. 2009/0103521 and 2009/0103560), all incorporated by reference herein for all purposes. With CTP, the network is monitored to determine if conditions are adequate to transmit time-based media at a rate sufficient for the recipient to consume the media in real-time. If not, steps are taken to generate and transmit on the fly a reduced bit rate version of the media for the purpose of enhancing the ability of the recipient to review the media in real-time, while background steps are taken to ensure that the receiving device 12 eventually receives a complete or synchronized copy of the transmitted media.

In yet another optional embodiment, a synchronization protocol may be used that maintains synchronized copies of the time-based media of transmitted and received messages sent between sending and receiving communication devices 12, as well as any intermediate server 10 hops on the network 14. See for example U.S. application Ser. Nos. 12/253,833 and 12/253,837, both incorporated by reference herein for all purposes, for more details.

In various other embodiments, the communication application 20 may rely on other real-time transmission protocols, including for example SIP, RTP, and Skype®.

Other protocols, which previously have not been used for the live transmission of time-based media as it is created, may also be used. Examples may include HTTP and both proprietary and non-proprietary email protocols, as described below.

### Addressing

If the user of a communication device 12 wishes to communicate with a particular recipient, the user will either select the recipient from their list of contacts or reply to an already received message from the intended recipient. In either case, an identifier associated with the recipient is defined. Alternatively, the user may manually enter an identifier identifying a recipient. In some embodiments, a globally unique identifier, such as a telephone number or email address, may be used. In other embodiments, non-global identifiers may be used. Within an online web community for example, such as a social networking website, an identifier may be issued to each member or a group identifier may issued to a group of individuals within the community. This identifier may be used for both authentication and the routing of media among members of the web community. Such identifiers are generally not global because they cannot be used to address an intended recipient outside of the web community. Accordingly the term “identifier” as used herein is intended to be broadly construed and mean both globally and non-globally unique identifiers.

### Progressive Emails

In one non-exclusive, late-binding embodiment, the communication application 20 may rely on “progressive emails” to support real-time communication. With this embodiment, a sender defines the email address of a recipient in the header of a message (i.e., either the “To”, “CC, or “BCC” field). As soon as the email address is defined, it is provided to a server 10, where a delivery route to the recipient is discovered from a DNS lookup result. Time-based media of the message may then be progressively transmitted across the network 14, from hop to hop, to the recipient, as the media is created and the delivery path is discovered. The time-based media of a “progressive email” can therefore be delivered progressively, as it is being created, using standard SMTP or other proprietary or non-proprietary email protocols.

Conventional email is typically delivered to user devices through an access protocol like POP or IMAP. These protocols currently do not support the progressive delivery of messages as they are arriving. However, by making simple modifications to these access protocols, the media of a progressive email may be progressively delivered to a recipient as the media of the message is arriving over the network. Such modifications include the removal of the current requirement that the email server know the full size of the email message before the message can be downloaded to the client communication device 12. By removing this restriction, the time-based media of a “progressive email” may be rendered as the time-based media of the email message is created, transmitted and received.

For more details on the above-described embodiments including late-binding and using identifiers, email addresses, DNS, and the existing email infrastructure, see co-pending U.S. application Ser. Nos. 12/419,861, 12/552,979 and 12/857,486, each commonly assigned to the assignee of the present invention and each incorporated herein by reference for all purposes.

### HTTP

In yet another embodiment, the HTTP protocol has been modified so that a single HTTP message may be used for the progressive real-time transmission of live or previously stored time-based media as the time-based media is created or retrieved from storage. This feature is accomplished by separating the header from the body of HTTP messages. By separating the two, the body of an HTTP message no longer has to be attached to and transmitted together with the header. Rather, the header of an HTTP message may be transmitted immediately as the header information is defined, ahead of the body of the message. In addition, the body of the HTTP message is not static, but rather is dynamic, meaning as time-based media is created, it is progressively added to the HTTP body. As a result, time-based media of the HTTP body may be progressively transmitted along a delivery path discovered using header information contained in the previously sent HTTP header.

In one non-exclusive embodiment, HTTP messages are used to support “live” communication. The routing of an HTTP message starts as soon as the HTTP header information is defined. By initiating the routing of the message immediately after the routing information is defined, the media associated with the message and contained in the body is progressively forwarded to the recipient(s) as it is created and before the media of the message is complete. As a result, the recipient may render the media of the incoming HTTP message live as the media is created and transmitted by the sender. For more details on using HTTP, see U.S. provisional application 61/323,609 filed Apr. 13, 2010, incorporated by reference herein for all purposes.

### Message Types and Format

Two or more communication devices 12 running the application 20 communicate with one another using individual message units, hereafter referred to as “Vox messages”. By sending Vox message units back and forth over the network 14, users may communicate with one another.

There are two types of Vox message units, including (i) message units that do not contain media and (ii) message units that do contain media. Message units that do not contain media are generally used for meta data, such as media headers and descriptors, contacts information, presence status information, etc. The message units that contain media are used for the transport of the media of messages.

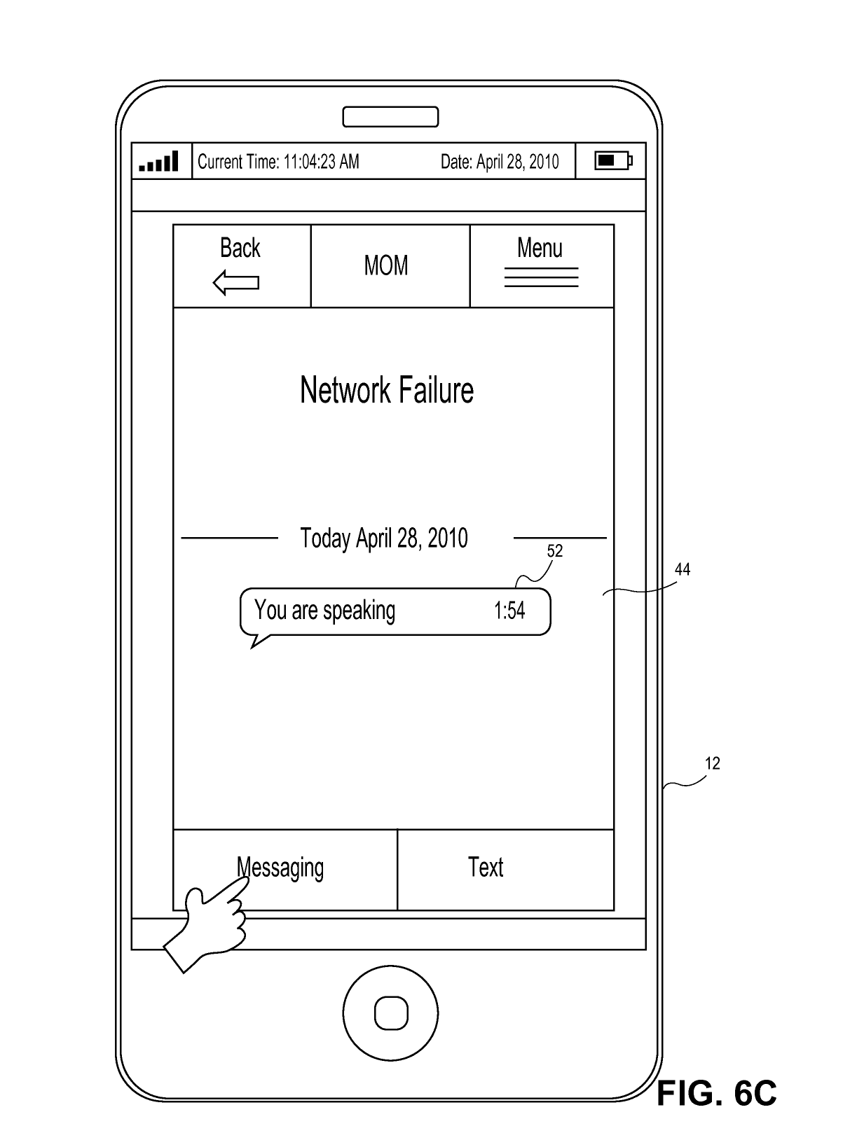

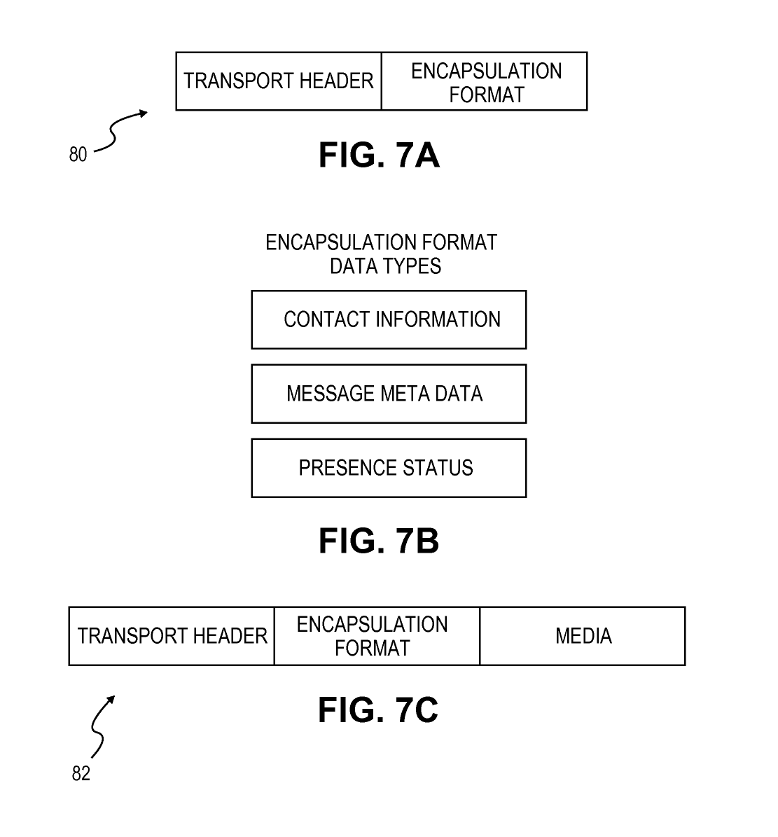

Referring to FIG. 7A, the structure of a Vox message unit 80 that does not contain media is illustrated. The message unit 80 includes a transport header field and an encapsulation format field for storing various objects, such as contact information, presence status information, or message meta data, as illustrated in FIG. 7B.

One type of meta data contained in messages 80 is information indicative of a call notification. When a sender selects the Call option, a message 80 containing meta data indicative of the notification is contained in the message header. In response, the receiving devices 12 of the recipient(s) generate the audio and/or visual notification for the recipients. Other types of meta data include conversation participant(s), identifiers identifying the participant(s), a date and time stamp, etc.

It should be understood that the list of objects provided in FIG. 7B is not exhaustive. Other objects, such as but not limited to, user location update information, user log-in information, information pertaining to the authentication of users, statistical information, or any machine-to-machine type message, may also be encapsulated in the encapsulation format field.

Referring to FIG. 7C, the protocol structure of a Vox message unit 82 that contains media is illustrated. The message unit 82 is essentially the same as a non-media type Vox message unit 80, except it includes an additional field for media. The media field is capable of containing one or multiple media types, such as, but not limited to, voice, video, text, sensor data, still pictures or photos, GPS data, or just about any other type of media, or a combination thereof.

The Vox message units 80/82 are designed for encapsulation inside the transport packet or packets of the network underneath the communication services network 14. By embedding the Vox message units 80/82 into existing packets, as opposed to defining a new transport layer for “Voxing,” current packet based communication networks may be used. A new network infrastructure for handling the of Vox message units 80/82 is therefore not needed.

### Early and Late Binding

In certain embodiments, the communication application 20 is late-binding. A sender may progressively transmit messages 80 and 82 containing both as soon as a recipient is identified, without having to first wait for a circuit connection to be established or a complete discovery path to the recipient to be fully defined. Late-binding allows a message 80 to be transmitted as soon as the header information (i.e., objects such as identifiers, contact information, presence status, notifications, etc.) is defined within the transport header field. With messages 82, the transport header field can be transmitted ahead of and separate from the field containing the media. In other words, as soon as a recipient and perhaps other objects are defined, the transport header of a message 82 may be transmitted. Time-based media may then be dynamically and progressively added to the body of the message 82, either as the media is created or retrieved from storage.

The communication application 20 implements late-binding by discovering the route for delivering the media associated with a message 82 as soon as a unique identifier used to identify a recipient is defined. The route is typically discovered by a lookup result of the identifier. The result can be either an actual lookup or a cached result from a previous lookup. At substantially the same time, the user may begin creating time-based media, for example, by speaking into the microphone, generating video, or both. The time-based media of the message 82 is then simultaneously and progressively transmitted across one or more server 10 hop(s) over the network 14 to the addressed recipient, using any real-time transmission protocol. At each hop, the identifier is used to discover the route to the next hop, either before or as the media arrives, allowing the media to be streamed to the next hop without delay and without the need to wait for a complete route to the recipient to be discovered.

With the selection of the Messaging option, the above-described late-binding steps occur at substantially the same time. A user may select a contact and then immediately begin speaking or generating other time-based media. With the selection of a contact, the transport header of a message 82 is created and transmitted. As the media is created, the real-time protocol progressively and simultaneously transmits the media across the network 14 to the recipient, without any perceptible delay, within the context of the body of the message 82. With the Call option, a message 80 containing a call notification is transmitted in a similar matter as soon as the recipient(s) are identified. In the event any of the recipient(s) elects to join the conversation live, then messages 82 are transmitted back and forth between the parties as described above.

The late binding of time-based media as the media is either created or retrieved from memory thus solves the problems with current communication systems, including the (i) waiting for a circuit connection to be established before “live” communication may take place, with either the recipient or a voice mail system associated with the recipient, as required with conventional telephony or (ii) waiting for an email to be composed in its entirety before the email with any attachments containing time-based media may be sent.

As noted above, the separation of the header from message bodies as described above with regard to either progressive emails or HTTP, may be used for late-binding communication. Although late-binding is described with regard to progressive emails and HTTP, it should be understood that any messaging protocol having message headers and bodies may be used.

In alternative early-binding embodiments, the recipient(s) of messages may be addressed using telephone numbers and Session Internet Protocol (SIP) for setting up and tearing down communication sessions between client communication devices 12 over the network 14. In various other optional embodiments, the SIP protocol is used to create, modify and terminate either IP unicasts or multicast sessions. The modifications may include changing addresses or ports, inviting or deleting participants, or adding or deleting media streams. As the SIP protocol and telephony over the Internet and other packet-based networks, and the interface between the VoIP and conventional telephones using the PSTN are all well known, a detailed explanation is not provided herein. In yet another embodiment, SIP can be used to set up sessions between client communication devices 12 using the CTP protocol mentioned above.

### Web Browser Embodiment

In yet another embodiment, the messaging application 20 is configured as a plug-in software module that is downloaded from a server to a communication device 12. Once downloaded, the communication application 20 is configured to create a user interface appearing within one or more web pages generated by a web browser running on the communication device 12. The communication application 20 is typically downloaded along with web content. Accordingly, when the user interface for application 20 appears on the display 44, it is typically within the context of a web site, such as an on-line social networking, gaming, dating, financial or stock trading, or any other on-line community. The user of the communication device 12 can then conduct conversations with other members of the web community through the user interface within the web site appearing within the browser. For more details on the web browser embodiment, see U.S. application Ser. No. 12/883,116 filed Sep. 15, 2010, assigned to the assignee of the present application, and incorporated by reference herein.

While the invention has been particularly shown and described with reference to specific embodiments thereof, it will be understood by those skilled in the art that changes in the form and details of the disclosed embodiments may be made without departing from the spirit or scope of the invention. For example, embodiments of the invention may be employed with a variety of components and methods and should not be restricted to the ones mentioned above. It is therefore intended that the invention be interpreted to include all variations and equivalents that fall within the true spirit and scope of the invention.

What is claimed is:

1. A messaging application embedded in a computer readable medium, the messaging application including:
a notification module configured to receive a notification that provides a notification that a sender of a message containing time-based media would like to engage in synchronous communication; and
a rendering module configured to enable a recipient of the message to render the message in either:
(a) a real-time mode as the time-based media of the message is received; or
(b) a time-shifted mode by rendering the time-based media of the message at an arbitrary later time after it was received; and
(c) one or more rendering options to seamlessly transition the rendering of the time-based media of the message between the two modes (a) and (b).

2. The messaging application of claim 1, further comprising a join module that enables the recipient to engage in synchronous communication with the sender in response to the notification.

3. The messaging application of claim 1, further comprising a screening module configured to enable the recipient of the incoming message to screen the message by rendering the time-based media of the incoming message as it is received, but without engaging in synchronous communication with the sender.

4. The messaging application of claim 1, further comprising an ignore feature that enables the recipient to ignore the message as the message is received.

5. The messaging application of claim 1, further comprising a storage module configured to progressively store in persistent storage the time-based media of the message as the time-based media of the incoming message is received.

6. The messaging application of claim 5, wherein the rendering module is configured to render the time-based media of the message in the time-shifted mode by retrieving and rendering the time-based media from persistent storage.

7. The messaging application of claim 1, wherein the rendering module provides one or more of the following rendering options: play, pause, replay, play faster, play slower, jump backward, jump forward, catch up to the most recently received media, Catch up to Live (CTL), or jump to the most recently received media.

8. The messaging application of claim 1, further comprising a transmit module configured to transmit an outgoing message to the sender of the incoming message.

9. The messaging application of claim 8, wherein the transmit module is further configured to transmit the outgoing message synchronously with respect to the incoming message.

10. The messaging application of claim 8, wherein the transmit module is further configured to transmit the outgoing message asynchronously with respect to the incoming message.

11. The messaging application of claim 8, wherein the outgoing message contains time-based media.

12. The messaging application of claim 8, wherein the outgoing message contains text media.

13. The messaging application of claim 1, wherein the incoming message is transmitted as a progressive email, the progressive email including:
a header containing an identifier associated with the recipient; and
a body which progressively streams the time-based media within the body of the progressive email as the time based media is progressively transmitted by the sender.

14. The messaging application of claim 1, wherein the incoming message is transmitted as an HTTP message, the HTTP message including:
a header containing an identifier associated with the recipient; and
a body which progressively streams the time-based media within the body of the HTTP message as the time based media is progressively transmitted by the sender.

15. The messaging application of claim 1, wherein the incoming message includes a message header and a message body containing the time-based media of the message.

16. The messaging application of claim 15, wherein the message header is received ahead of and separate from the message body.

17. The messaging application of claim 15, wherein the message header contains one or more of the following:
(i) a first identifier identifying the recipient of the message;
(ii) a second identifier identifying the sender;
(iii) presence status of the sender; and/or
(iv) meta data associated with the incoming message.

18. The messaging application of claim 1, further comprising a conversation module configured to string one or more transmitted and/or received messages into a conversation.

19. The messaging application of claim 18, further comprising a display module configured to display the one or more transmitted and/or received messages of the conversation in time-indexed order.

20. The messaging application of claim 19, wherein the rendering module is further configured to render the media of a selected message among the one or more transmitted and/or received messages of the conversation by selecting the selected message when displayed by the display module and then rendering the media of the selected message from storage.

21. The messaging application of claim 18, wherein the conversation module strings the transmitted and/or received messages into the conversation based on a common attribute, the common attribute comprising one of the following:
(i) a conversation name;
(ii) a name of a participant of the conversation;
(iii) a name of a user group; or
(iv) a conversation topic.

22. A messaging application embedded in a computer readable medium, the messaging application including:
a message module configured to generate a message containing time based media;
a transmit module configured to progressively transmit the time-based media of the message to a recipient as the media is created in either:
(i) a messaging mode where the time-based media of the message is transmitted before a delivery route to the recipient is completely discovered; or
(ii) a call mode after providing a notification requesting synchronous communication and receiving a confirmation that the recipient would like to engage in synchronous communication.

23. The messaging application of claim 22, wherein the messaging mode is implementing with a start message and an end message function.

24. The messaging application of claim 23, wherein the start message function and the end message function are implemented by one of the following:
(i) asserting a messaging function for the duration of the message; or
(ii) asserting start and stop functions.

25. The messaging application of claim 22, wherein the notification comprises an audio notification, a visual notification, or both audio and visual notifications.

26. The messaging application of claim 22, wherein the messaging module is further configured to generate a text message and the transmit module is further configured to transmit the text message to the recipient.

27. The messaging application of claim 22, wherein the message generated by the message module comprises a message header and a message body.

28. The messaging application of claim 27, wherein the message body is configured to dynamically increase in size as the time-based media of the message is progressively created and added to the message.

29. The messaging application of claim 27, wherein the message header contains one or more of the following:
(i) a first identifier identifying the recipient of the message;
(ii) a second identifier identifying the sender;
(iii) information indicative of the presence status of the sender; and/or
(iv) meta data associated with the incoming message.

30. The messaging application of claim 28, wherein the transmit module is further configured to transmit the message header ahead of and separate from the message body.

31. The messaging application of claim 27, wherein the message is a progressive email including the message header and the message body, wherein the message body progressively streams the time-based media of the message as the time based media is created and progressively transmitted by the transmit module.

32. The messaging application of claim 27, wherein the message is an HTTP message including the message header and the message body, wherein the message body progressively streams the time-based media of the message as the time based media is progressively transmitted by the transmit module.

33. The messaging application of claim 30, wherein the transmit module is further configured to progressively transmit the time-based media of the message as the media is created along a delivery route discovered using an identifier associated with the recipient and contained in the message header.

34. The messaging application of claim 30, wherein the transmit module is further configured to progressively transmit the time-based media of the message along the delivery route before the message is complete.

35. The messaging application of claim 22, further comprising a storage module configured to progressively store the time-based media of the message in persistent storage as the media is created.

36. The messaging application of claim 35, wherein the transmission module is further configured to transmit the time-based media from persistent storage after a communication device executing the communication applications connects to a communication network after being disconnected from the network when the time-based media of the message was created.
